(19) United States
(12) Patent Application Publication
(10) Pub. No.: US 2017/0048564 A1
(43) Pub. Date: Feb. 16, 2017

(54) DIGITAL MEDIA SPLICING SYSTEM AND METHOD

(71) Applicant: STARFISH TECHNOLOGIES LTD, Reading, Berkshire (GB)

(72) Inventor: Michel Roujansky, Saint-Georges sur Loire (FR)

(21) Appl. No.: 15/305,459

(22) PCT Filed: Apr. 23, 2015
(86) PCT No.: PCT/EP2015/058847

§ 371 Date: Oct. 20, 2016

(30) Foreign Application Priority Data
Apr. 23, 2014 (GB) 1407148.4

(51) Int. Cl. H04N 21/234; H04N 19/85; H04N 21/845; H04N 19/40; H04N 21/236; H04N 21/854; H04N 19/177

(52) U.S. Cl. CPC H04N 21/23424; H04N 21/854; H04N 19/85; H04N 19/177; H04N 19/40; H04N 21/236; H04N 21/8456

(57) ABSTRACT

The present invention relates to a system and method of inserting a second stream of digital frames into a primary stream of digital frames, where the primary stream is encoded according to a first format. The approach comprises determining a reference point in the primary stream; determining a section of the primary stream adjacent the reference point; creating a corresponding recoded version of the adjacent section of primary stream, such that the recoded version is in a second format where each frame in the recoded version is independent of a succeeding frame; replacing the section of the primary stream with the corresponding recoded version, and inserting the second stream adjacent the replaced section.

### FIELD OF THE INVENTION

The present invention relates to a system and method for inserting digital media into a main digital media stream. More particularly the present invention relates to a system and method for splicing at least two compressed digital streams, particularly video and/or audio streams, to form a single compressed digital stream.

### BACKGROUND

The process of splicing two analogue signals is relatively simple, as you simply find a vertical interval, and execute a switch between the two signals. This is a simple technique where the signals are synchronous and time-aligned.

For base-band digital signals, each frame is discrete, and so these signals can be readily spliced. However digital signals are not typically transmitted in base-band form, but instead encoded into a more efficient form, such as by using MPEG-2 or MPEG-4 which employ inter-frame coding.

MPEG (Moving Picture Experts Group) is a working group that sets standards for audio and video compression and transmission. Digital video compression is a process that, for example, removes redundancy in the digital video pictures. The redundancy between pictures in a video sequence can amount to a spatial redundancy and/or a temporal redundancy. MPEG coding, and particularly the more recent coding standards, starting with MPEG-2 compression, takes advantage of these redundancies by efficient coding. Accordingly the resulting representation is smaller in size that the original uncompressed pictures. MPEG encoding is highly statistical in nature, and lossy, as it essentially throws away content that is unlikely to be missed.

Whilst inter-frame coding, exploiting the temporal redundancies between adjacent frames by storing the differences between the frames rather than each frame in its entirety, advantageously reduces the amount of data to be transmitted, it makes splicing into the signal difficult. In other words, since frames are typically dependent upon adjacent frames, splicing into such an encoded stream is likely to interrupt the encoding interrelationship and prevent frames around the splice point being decoded cleanly.

Digital stream insertion is essentially a process where a part of a primary digitally compressed stream is replaced by another secondary compressed stream. A particular application of this process is with programmes for transmission or broadcast, which have been compressed at a first location (e.g. by the programme maker) and then sent to a second location (e.g. a transmission facility for a local community). It may be desirable for those at the second location to insert information, such as advertisements, that are specific or relevant to their local community (i.e. locally targeted advertising or other regionally specific content). This is not a functionality that the programme distributer is typically willing to do on another's behalf, particularly when they are distributing the programme around a multitude of different transmission facilities, each with their preferred local content for insertion.

Where the programme is being streamed in real-time, or substantially real time, to local transmission facilities, it would also be desirable for the local transmission facilities to be able to insert a secondary advertisement stream into the live network feed. Of course this is not a simple matter when that live network feed is compressed.

It is to be appreciated that the technique of “insertion” is equivalent to “splicing”. That is it refers to the process whereby a transition is made from a primary stream to one or more secondary streams, and then, typically, back to the primary stream.

The simplest way to splice television programmes is in the baseband signal before compression occurs. This technique works well when the programme streams are received at the cable head-end in uncompressed form. However, when the programme is distributed in the form of an MPEG transport stream, to do so would require the stream to be fully decompressed and then recompressed with the inserted clips, which is a costly proposition, particularly in terms of quality, time and required processing power.

Where the signals or streams are compressed, the splicing process is complex, as not only are packets/frames in MPEG streams dependent upon adjacent packets in the stream, but MPEG coding schemes also utilise variable length encoding of digital video pictures. These factors all need to be considered when decoding MPEG streams.

More specifically, MPEG compression utilises a number of different frame/picture types, I-, P- and B-frames, which serve different purposes. These different frame types have different numbers of bytes and as a result, different transmission times. More particularly:
I-frames, or Intra-frames, can be fully decoded without reference to (and/or independently of) any other frames. That is they are encoded using only information present in the picture itself;
P-frames, or Predicted-frames, are used to improve compression by exploiting the temporal redundancy in a scene. P-frames store only the difference in image from the frame immediately preceding them. The immediately preceding frame is therefore a point of reference, and typically called the anchor frame; and
B-frames, or Bidirectional-frames, like P-frames are also used to improve compression, although this time by making predictions using both the previous and future frames (i.e. two anchor frames). Accordingly, in order to decode a B-frame, the next sequential frame must be decoded first, which means decoding B-frames requires large data buffers.

These frames are grouped into sequences, in MPEG coding. In MPEG-1 and MPEG-2 they are known as a “Group of Pictures” (GOP) whilst in MPEG-4/H.264 they are called a “Coded Video Sequence” (CVS). Henceforth, the term GOP will be used to describe such a sequence of frames. Such GOP sequences typically contain a combination of all of these frame types. Now because of the dependency of P- and B-frames on anchor frames, it is not possible to cut one stream on a B-frame and enter the next on a P-frame because the anchor frames would no longer be correct.

The prior art has attempted to address this problem by requiring the initial encoder of an MPEG stream to use what is known in MPEG-1/2 compression as a closed GOP restriction, whilst in MPEG-4 the requirement is that each Coded Video Sequence starts with an IDR frame which means a GOP or a CVS can be fully decoded without reference to any frames outside the sequence. This requires additional processing by the encoder, particularly where the last frame of a GOP is a B-frame, and also reduces the effectiveness of the MPEG compression.

A further known approach has attempted to avoid the need to decompress the original content by using special encoders to include advertising insertion markers in the transport stream to indicate predetermined points at which splicing may occur. These systems are of course inflexible in regard to the points of insertion.

A further problem in splicing two digitally encoded streams is resolving timing differences between the two streams. Since each stream is typically independent of each other, each stream would contain its own timing information which would be specific to the stream itself. Therefore, upon splicing the two streams, the timing information would become inaccurate (i.e. it would create a discontinuity in the time base).

There is therefore a need to overcome or ameliorate at least one problem of the prior art.

In particular, there is a need for an improved system and method for enabling insertion of video and/or audio clips into an MPEG transport stream.

### SUMMARY OF THE INVENTION

According to a first aspect, the present invention provides a method as defined in claim 1.

Other aspects of the invention are defined in the attached claims.

The insertion can be performed in regard to a compressed primary stream and/or a compressed second stream since each frame in the recoded version is independent of a succeeding frame.

An advantageous format for the recoded version is an I-frame only format. Whilst I-frames have a larger file format than compressed frame formats, the I-frames are encoded at the same bit rate as the replaced material and therefore have the same size, albeit at a lower definition. By having the recoded version in a format that is not dependent upon preceding and subsequent packets, compressed clips can readily be inserted in, or on either side of, the recoded version incorporated into the original compressed stream without needing to decode the compressed clips or the compressed original stream.

Although an I-frame only MPEG transport stream has a lower definition than an MPEG transport stream containing I-, B- and P-frames for the same bit rate, since the recoded I-frame frames incorporated into the MPEG transport stream relate to the same content as the replaced portion, and are displayed for a short period of time (e.g. less than one GOP), the lower definition is unnoticeable to the human eye.

A second advantageous format for the recoded of version is to use GOPs encoded with I-frames and P-frames, where the first frame of the GOP is preferably an I-frame. P-frames are only dependent on previous frames and therefore also offer the capability to interrupt the stream and insert new material at any place in the stream.

The advantage of using P-frames is that they offer a higher compression ratio than I-frames. Therefore, the quality of the recoded video is higher when using GOPs encoded with I-frames and P-frames as opposed to I-frames alone.

A particular advantage of these aspects of the invention is that they enable the secondary stream to be spliced into the main stream at an insertion point that is ideally decided by the entity performing the insertion. That is, the main stream does not need to be pre-conditioned or have insertion points already designated. These aspects of the invention therefore have greater flexibility than existing prior art approaches.

A further advantage is that insertion of the secondary stream may occur without requiring either the inserted material or the majority of the primary stream to undergo decompression/recompression: it is only a portion of individual GOPs of the primary stream at the boundaries of the inserted material that need to be converted to an I-frame only or an I-frame and P-frame only stream.

### BRIEF DESCRIPTION OF THE DRAWINGS

The embodiments of the invention will now be described in more detail with reference to the accompanying Figures, in which:

FIG. 1 provides a graphical illustration of frame accurate insertion using I-frames according to an embodiment of the invention;

FIG. 2 illustrates a splicing apparatus according to an embodiment of the invention;

FIG. 3 illustrates an approach for inserting files or packets according to an embodiment of the invention; and

FIG. 4 illustrates an approach for inserting files or packets according to a further embodiment of the invention.

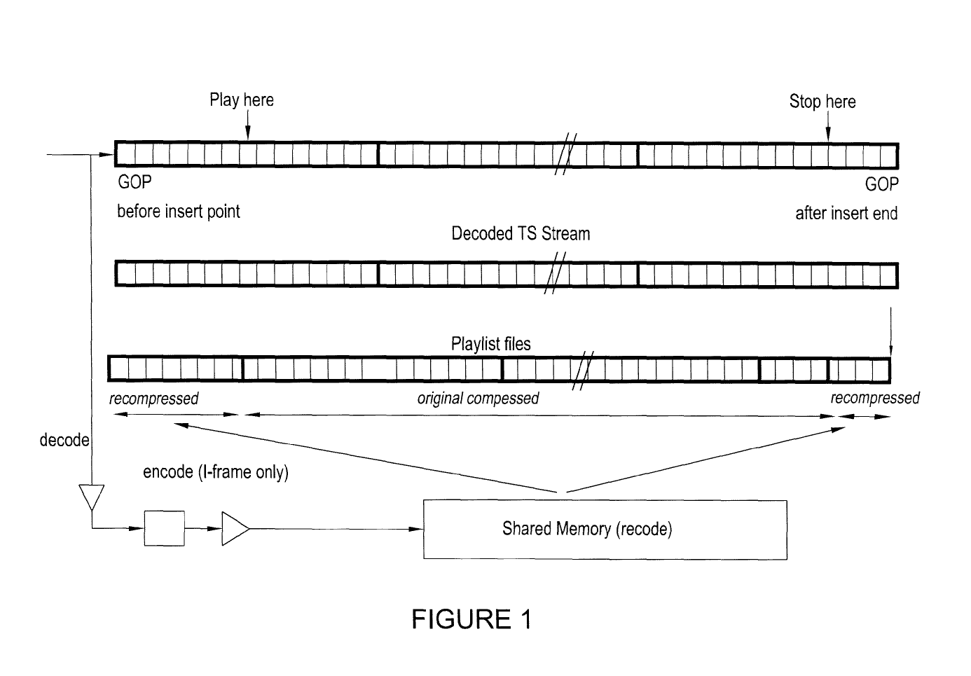

### DETAILED DESCRIPTION

The MPEG-2 standards define how to format the various component parts of a multimedia programme (which may consist of: MPEG compressed video, compressed audio, control data and/or user data). It also defines how these components are combined into a single synchronous transmission bit stream. MPEG transport stream is specified in MPEG-2 and is a standard format for transmission and storage of data including audio, video, Programme and System Information Protocol (PSIP) data and combinations thereof. It specifies a container format encapsulating packetised elementary streams, with error correction and stream synchronisation features for maintaining transmission integrity when the signal is degraded.

MPEG-2 transport streams are typically used in broadcast systems such as DVB, ATSC and IPTV. However, it is not exclusively used in broadcasting, as it has been adapted for use by digital video cameras, recorders and the like. Therefore the following description, although having particular application to a broadcast system is not to be considered as limited to this field.

To encode/multiplex, a multimedia stream, it is first broken down into its component parts, being streams of video, audio, subtitles, control data etc. Each of these streams is known as an “Elementary Stream” in MPEG. To compress these elementary streams, each are input to an MPEG-2 processor which accumulates the data into a stream of Packetised Elementary Stream (PES) packets. The PES packets may be of a fixed or variable size. Each PES packet includes a header which typically includes a Presentation Time Stamp (PTS) and possibly a Decode Time Stamp (DTS). These time stamps are used to synchronise the elementary streams and control the rate at which each are replayed by the receiver.

The MPEG-2 standard allows two forms of multiplexing, being MPEG Programme Stream multiplexing and MPEG Transport Stream (MPEG-TS) multiplexing.

The embodiments of the present invention have particular application to the MPEG Transport Stream multiplexing, where each PES packet is broken into fixed sized transport packets, enabling one or more streams to be combined.

Packets in the MPEG Transport Stream include a header containing a Packet Identifier (PID). Each packet is associated with a PES through the setting of the PID value. The MPEG-TS is not time division multiplexed, and so packets with any PID may be inserted into the TS at any time. If no packets are available, the multiplexor inserts null packets to retain the specified Transport Stream bit rate. The multiplexor also does not synchronise PES packets, so the encoding and decoding delay for each is typically different. A separate process is therefore required to synchronise the streams.

According to a first embodiment of the invention, an approach is described for enabling one or more media clips to be inserted into a main broadcast programme stream without the need to decompress/recompress the inserted material or the bulk of the main programme stream.

The main programme stream (often described as the “from-stream”) is preferably encoded at a constant bit-rate with a minimum of 5% null packets. These null packets allow some flexibility in the positioning of packets during replacement of the original material and insertion of the clip material.

Also, the clip or clips to be inserted are preferably compressed in the same format as the main programme stream and at speeds lower or equal to the speed of the from-stream to be replaced. Again, this will ensure a suitable reproduction (i.e. smooth interface) of the inserted clips to the end consumer.

The clip streams also preferably have a Programme Clock Reference (PCR) repetition interval less than or equal to that of the main programme stream. The PCR repetition interval is the time interval between two consecutive PCR values. The purpose of this is to avoid having large variations in the PCR repetition interval. It is to be appreciated that this is not an essential requirement, and if the PCR of the inserted material does not meet this requirement, it would be possible to insert extra PCR packets, however this would require much more manipulation of the inserted stream.

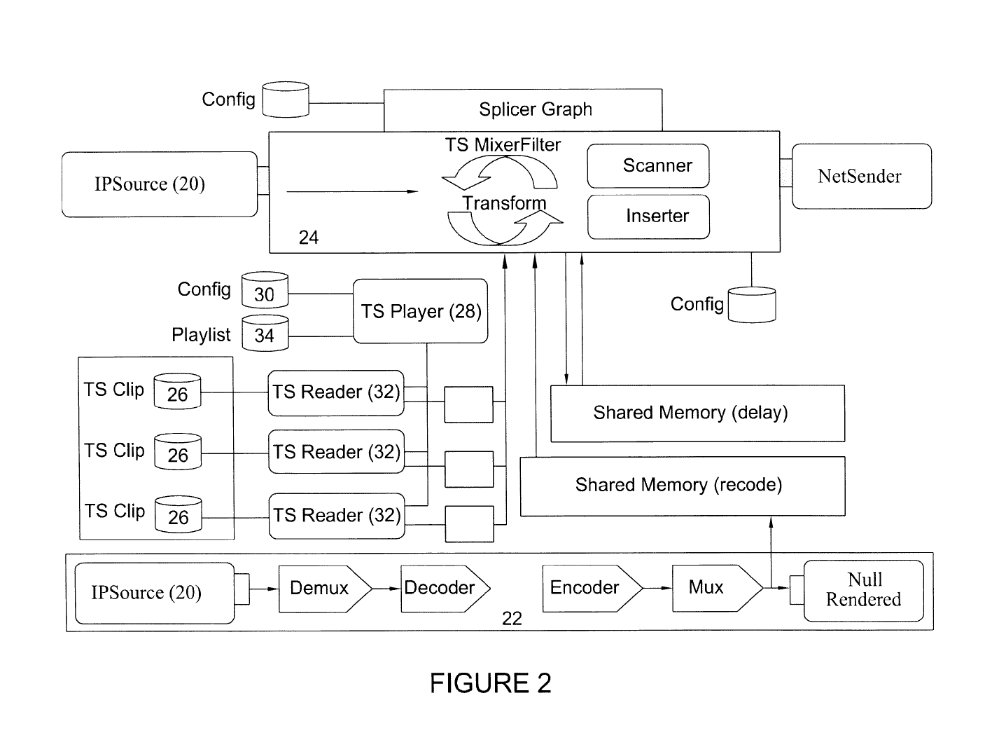

In this embodiment of the invention, the insertion point may be determined by the party/entity inserting the clip or it may be predetermined. This insertion point may be at the boundary of two Groups of Pictures (GOPs) but will typically be within a GOP. A Splicer (FIG. 2), upon being informed of this insertion point, will analyse the point relative to the incoming main programme stream (20), and determine the GOP (where the insertion point is at a GOP boundary) or the portion of the GOP immediately preceding the insertion point. This preceding GOP or GOP portion is provided to a Recoder component (22) of the Splicer, which decodes it, having knowledge of the surrounding GOPs, and re-encodes it in an I-frame only or an I-frame and P-frame only format. The I-frame only or I-frame and P-frame only segment is preferably encoded at the same speed as the main programme stream (20).

This re-encoded I-frame only or I-frame and P-frame only portion is then reinserted into the main broadcast stream by a Mixer component (24) of the Splicer, replacing its corresponding component in the stream immediately before the insertion point. The recoded inserted frames have the same visual content as the replaced frames, albeit with a lower definition, and therefore will not be noticed by the human eye, as they are typically displayed for less than one GOP.

According to a further embodiment of the invention, which may be utilised separately or in conjunction with the first embodiment of the invention, a splicing exit point is also designated by the party/entity inserting the clips or it may be predetermined. Again, like the insertion point, this exit point may be at the boundary of two GOPs but will typically be within a GOP. In this embodiment, the Splicer will analyse the exit point relative to the incoming main programme stream (20), and determine the GOP or the portion of the GOP immediately following the exit point. This GOP portion is provided to the Recoder component (22) of the Splicer, which decodes it, having knowledge of the surrounding GOPs and re-encodes it in an I-frame only or an I-frame and P-frame only format. This re-encoded portion then replaces the corresponding portion of the “from stream” from the exit point up to the next GOP boundary. This is achieved in a similar manner to the replacement of the “from stream” last GOP up to the insertion point, as described above, and is typically utilised in conjunction with that embodiment.

It is to be appreciated that since the I-frames or I-frame and P-frames are encoded at the same rate as the original material, the portion is of the same size, and so it is a simple replacement.

Once the I-frame only or an I-frame and P-frame only portion, or portions, are in place, the MPEG clips (26) may be spliced into the main MPEG stream.

When using re-encoded GOPs consisting of I-frames and P-frames, upon inserting a clip and returning to the “from stream”, it is advantageous to start the GOP or the portion of the GOP immediately following the exit point to be an I-frame which precisely corresponds to the frame of the previously re-encoded segment, as the exit point may be located at a P-frame.

The splicing procedure, according to a further embodiment of the invention will now be described. This procedure of course uses the compressed main programme transport stream adapted as per the embodiments of the invention described above.

The Mixer component (24) of the Splicer manages the insertion of the clips (26) into the main programme stream (20) using an algorithm designed to avoid stream corruption and lip-synchronisation problems. The splicing algorithm has also been designed so as to minimise the risk of downstream buffers experiencing underflow or overflow.

In this regard, to splice one or more compressed clips (e.g. using MPEG-2 compression) into the main compressed programme stream, the Mixer (24) will importantly make an appropriate adjustment to the timing of the packets in order to account for the duration needed by the Recoder (22) to decode and recode the GOP portion. In other words, the Mixer (24) will incorporate an equivalent delay into the main stream signal.

The Mixer (24) processes the incoming “from stream” (20) by, for each packet passing through, determining a Programme Clock Reference (PCR) of the packet, and for video packets a theoretical Presentation Time Stamp (PTS) and Decode Time Stamp (DTS). As the Mixer (24) knows the desired PCR corresponding to the insertion point, when this is reached it starts inserting packets from the clip or clips to be inserted when necessary. Packets are inserted sequentially when the computed PCR of the from-stream becomes higher than the adjusted PCR for the to-be-inserted packet.

A Player/Reader component of the Splicer assists with the insertion of the clips. A “cue” command is issued at the point/time of insertion, at which point the Player (28) parses the clip or clips (26) to be inserted.

When the insertion point is reached, the Mixer (24) switches from pass-through mode to splicing mode.

The Player (28) make use of a configuration file (30), which sets out which Packet IDs (PIDs) are to be replaced during insertion. It also utilises a playlist (34), which defines the clips to be inserted, and for each clip, the PIDs of the clip packets to be inserted. Preferably the playlist (34) also associates the PIDs of the packets to be inserted with the PIDs from the original stream being replaced (i.e. as defined in the configuration file). The PIDs from the original stream being replaced are described as drop-PIDs. That is, packets from the “from-stream” which are to be replaced or dropped during the insertion are marked as “drop-PID packets”. The Mixer (24) references the configuration file (30), and where the PID is indicated as a drop-packet, a drop-RID flag is set.

It is to be appreciated that it may eventuate that packets marked as drop-PIDs are not actually replaced once insertion of the clip packets is performed. Where this occurs, the non-replaced drop-PID packets are preferably marked as null packets in order to preserve the total number of packets in the incoming “from stream” (20).

When clip packets (26) are inserted into the main stream, the inserted clip packets are marked with the PIDs from the replaced stream (e.g. using the playlist). Clip packets are inserted in their original order when their relative PCR becomes higher than the “from stream” PCR.

Also, in order to maintain synchronicity between the original stream and the inserted clips, and for the eventual decoder to make sense of the spliced stream, the PCR, PTS and DTS values of the inserted packets are adjusted relative to the insert start point. That is, during its initial analysis the Reader (32) would have determined the position (i.e. the offset relative to the insert position), PCR and PTS and possible DTS of the first and last video and audio packets to be inserted (assuming the programme stream comprises both video and audio). Once these packets are inserted, appropriate adjustments to these values are made relative to the start point of the original “from stream” (for instance, the position of an inserted packet would be adjusted by the offset from the insert start point and the PCR would also be adjusted to incorporate an equivalent temporal offset).

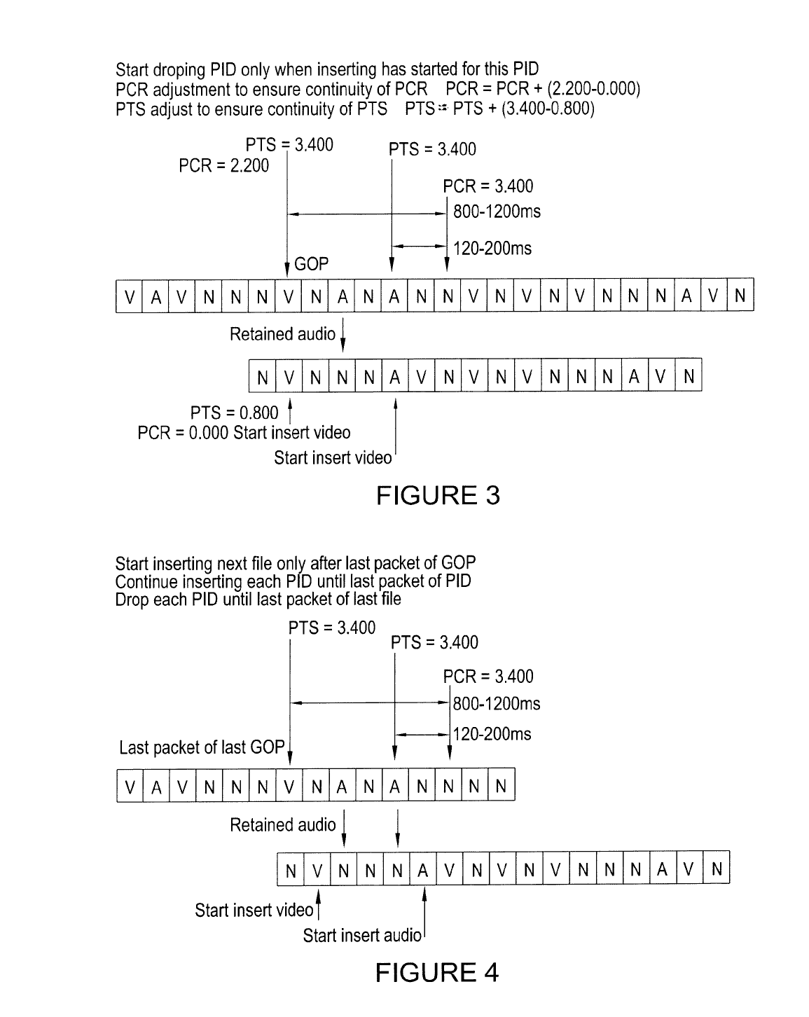

An example of how the adjustments of the PCR and PTS are made is shown in FIG. 3. In FIG. 3, the first stream is the “from”-stream and the stream illustrated below that is the clip inserted stream. The point where video insertion starts is marked with reference to the clip inserted stream (i.e. at this point the first video packet is inserted). This point corresponds to a PCR=0.0000 and PTS=0.800. Relative to the insertion point, in the from-stream, the PCR=2.200 and PTS=3.400. Therefore, to ensure continuity of the PCR and PTS/DTS values in the final stream, adjustments can be made as follows:

$$\begin{matrix}{PCR}_{adjusted} = {PCR}_{from stream insertion point} + {PCR}_{difference in streams} \\ = {PCR}_{from stream insertion point} + ( 2.200 - 0.000 )\end{matrix}$$

$$\begin{matrix}{PTS}_{adjusted} = {PTS}_{from stream insertion point} + {PTS}_{difference in streams} \\ = {PTS}_{from stream insertion point} + ( 3.400 - 0.800 )\end{matrix}$$

It is also to be appreciated that after the first video packet is inserted, in this embodiment of the invention follow-on audio packets in the from-stream are retained until the first audio packet from the clip is ready for insertion. In FIG. 3, this can be seen in that the third packet in the from-stream after the start of the video insertion point is an audio packet and is therefore retained. The audio for the inserted clip is then started at the fifth packet from the insertion point. This occurs because the video stream is transmitted well ahead of the audio stream (typically 500 ms to 1 s ahead) both in the from-stream and in the inserted video stream. Such audio retention is the way an MPEG transport stream is normally organised, so the insertion algorithm according to this embodiment of the invention takes this into account.

In addition to adjustment of the PCR/PTS/DTS values, appropriate adjustments should also be made in the output stream to continuity counters incorporated into the packets.

An alternative approach to maintain synchronicity is to mark the splice points as discontinuities, such by using the discontinuity indicator (a field of the MPEG transport stream). In this approach, however, it is the PTS/DTS of the retained streams which must be modified in order to match the new PCR.

Where consecutive clips are inserted in the “from stream”, one after another, the insertion offset is preferably adjusted for each clip according to its actual start of insertion position in the “from stream”. Also, on clip boundaries, in order to ensure that the PTS-PCR offset remains within stable values throughout the splice, video from the follow-on clip is preferably inserted after the end of the previous clip video, in parallel with the previous clip audio.

The procedure at the boundary between two streams/clips is illustrated in FIG. 4. The top stream is a mixed stream of two clips and the lower stream a follow-on clip. Insertion of video packets is only commenced after the last packet of the last GOP of the mixed stream: this point is indicated on the top mixed stream and corresponds to PTS=3.400. After this video insertion point, follow on audio packets in the mixed stream are retained until the first audio packet of the follow on clip is inserted (i.e. referring to FIG. 4, the first and third packets after the first inserted video packet from the mixed stream are retained: the first audio packet of the follow on clip is inserted as the fourth packet after the first inserted video packet).

To more specifically describe the operation of the Splicer in this embodiment of the invention, once the insert start point has been reached, and the Mixer (24) is operating in splicing mode, for each subsequent packet, the Mixer component (24) determines if the packet is a null packet or a drop-PID one. Where this is the case, the Mixer (24) requests from the current Reader (32) whether the next packet to be inserted is available.

It is to be appreciated that the current” Reader (32) refers to the Reader for the clip (26) being inserted. In other words, where there are multiple clips (26), multiple Readers (32) are typically used (see FIG. 2). It is also to be appreciated that the Mixer (24) and the Reader (32) cooperate so as to splice the clips (26) into the main stream in a manner which maintains the speed compatibility. In this regard, after the current Reader (32) has parsed its clip file (26), it positions itself at the beginning of the file, in synchronicity with the main stream, and waits for a packet request from the Mixer (24). Where time passes, and no requests are received, the Reader (32) will skip packets as appropriate, and will position itself on the first packet to be inserted. Upon a packet insert request being received, a temporally appropriate packet will be provided. That is, a particular packet will be provided when the request time is higher than that packet's relative PCR from the clip's first insert packet. The Reader (32) will continue in this manner, skipping packets as appropriate until the next insert packet is requested, and until the last packet to be inserted has been reached. This will be signalled to the Mixer (24). Where additional clips (26) are to be inserted, the Mixer (24) will then move to the next Reader (32), and the same process will be repeated. It is to be appreciated that the location of the next Reader (32) is typically signalled to the Mixer (24) by the Player component (28) of the Splicer.

From the Mixer's viewpoint, upon determining a null or drop-PID packet, if an insert packet is available from the current Reader (32), the Mixer (24) inserts it in place of the current null/drop-PID packet. As indicated above, it is to be appreciated that a packet will be provided by the Reader (32) where a current packet exists at a corresponding PCR relative to the clip's insert commencement point. The PID of the inserted packet, as well as the eventual PCR and PTS/DTS are adjusted as needed. If no packet is available, however, then the Mixer (24) sets the current packet of the main stream to null. The Mixer (24) also adjusts the packet's continuity counter, as necessary.

This process is made possible by the recoding of the GOPs immediately preceding the insertion point. This enables a seamless and frame accurate splicing to be achieved.

The present invention has been described as having particular application to MPEG coding schemes, such as MPEG-2 and MPEG-4 digital video compression. The present invention however may also be applied to other compression schemes such as the H.26X for video conferencing. When applying the present invention to other compression schemes, such as H.26X, the I-, P- and B-frames may be replaced with equivalents. For example, l-frames may be replaced by IDR frames when using the H.264 compression scheme.

Additionally, the present invention has been described using the term Group of Pictures, GOPs, which is a general term used to refer to a section of an encoded stream comprising more than one type of frame.

The embodiments of the invention have particular application to streams transmitted over radio frequency links (UHF/VHF). digital broadcast satellite links, cable TV networks, standard terrestrial communication links (PDH, SDH), microwave line of sight links, digital subscriber links (ADSL), packet/cell links (ATM, IP, Ethernet).

The embodiments described are to be taken as illustrative of the invention and not limitative. For instance, the order of steps is not essential to the invention and may be reordered whilst still retaining the essential functionality of the invention.

1. A method of inserting a second stream of digital frames into a primary stream of digital frames, where the primary stream is encoded according to a first format, the method including:
determining a reference point in the primary stream;
determining a section of the primary stream adjacent the reference point;
creating a corresponding recoded version of the adjacent section of primary stream, such that the recoded version is in a second format where each frame in the recoded version is independent of a succeeding frame;
replacing the section of the primary stream with the corresponding recoded version, and
inserting the second stream adjacent the replaced section.

2. The method of claim 1 wherein the second format is an I-frame only stream.

3. The method of claim 1 wherein the second format is a Group of Pictures, GOP, consisting of I-frames and P-frames.

4. The method of claim 3 wherein the first frame of the Group of Pictures, GOP, is an I-frame.

5. The method of claim 1, wherein the second stream of digital frames that is inserted is also encoded according to the first format of the primary stream.

6. The method of claim 1, wherein the reference point is located in a Group of Pictures, GOP, and the step of determining a section of the primary stream adjacent the at least one reference point comprises determining a section of the GOP adjacent the at least one reference point.

7. The method of claim 1, wherein the reference point is an insertion point and the section of the primary stream adjacent the insertion point is a portion of a Group of Pictures, GOP, immediately preceding the insertion point, from a previous GOP boundary up to the insertion point.

8. The method of claim 1, wherein the reference point is an exit point and the portion of the primary stream adjacent the insertion point is a portion of a GOP immediately following the exit point, from the exit point up to the next GOP boundary.

9. The method of claim 1, wherein the primary stream includes timing information, and the method further includes adjusting the timing information in the primary stream to account for a delay in recoding the section of the primary stream.

10. The method of claim 9, wherein the first format is an MPEG transport stream and the timing information adjusted includes at least one of a current Programme Clock Reference, PCR, a Decoding Time Stamp, DTS and a Presentation Time Stamp, PTS.

11. The method of claim 1 wherein the section of the recoded version corresponds to the section of the primary stream in terms of having the same visual content.

12. The method of claim 1, wherein the insertion of the second stream comprises inserting video and audio packets into the primary stream.

13. The method of claim 12 further including, after a first video packet of the second stream is inserted into the primary stream, retaining audio packets of the primary stream until a first audio packet of the second stream is inserted.

14. A system for inserting a second stream of digital frames into a primary stream of digital frames, where the primary stream is encoded according to a first format, the system comprises a processor adapted to;
determine a reference point in the primary stream;
determine a section of the primary stream adjacent the reference point;
create a corresponding recoded version of the adjacent section of primary stream, such that the recoded version is in a second format where each frame in the recoded version is independent of a succeeding frame;
replace the section of the primary stream with the corresponding recoded version; and
insert the second stream adjacent the replaced section.

15. The system of claim 14, wherein the processor is configured to encode the second stream of digital frames that is inserted according to the first format of the primary stream.

16. The system of claim 14 wherein the reference point is located in a Group of Pictures, GOP, and the processor is operable to determine a section of the primary stream adjacent the at least one reference point by determining a section of the GOP adjacent the at least one reference point.

17. The system of claim 14 wherein the reference point is an insertion point and the section of the primary stream adjacent the insertion point is a portion of a Group of Pictures, GOP, immediately preceding the insertion point, from a previous GOP boundary up to the insertion point.

18. The system of claim 14 wherein the reference point is an exit point and the portion of the primary stream adjacent the insertion point is a portion of a GOP immediately following the exit point, from the exit point up to the next GOP boundary.

19. The system of claim 14, wherein the primary stream includes timing information, and the processor is further configured to adjust the timing information in the primary stream to account for a delay in recoding the section of the primary stream.

20. The system of claim 19, wherein the first format is an MPEG transport stream and the timing information adjusted includes at least one of a current Programme Clock Reference, PCR, a Decoding Time Stamp, DTS and a Presentation Time Stamp, PTS.
